(19) United States
(12) Patent Application Publication
(10) Pub. No.: US 2015/0026003 A1
(43) Pub. Date: Jan. 22, 2015

(54) Extended Commerce Platform for Organized and Unorganized Business Sectors

(71) Applicant: Ramesh Baswa, Hyderabad (IN)

(72) Inventor: Ramesh Baswa, Hyderabad (IN)

(73) Assignee: Sollet Soft Solutions Pvt. Ltd., Hyderabad (IN)

(21) Appl. No.: 13/943,554

(22) Filed: Jul. 16, 2013

(51) Int. Cl. G06Q 30/06; G06Q 20/12; G06Q 20/36

(52) U.S. Cl. CPC G06Q 30/0633; G06Q 20/36; G06Q 20/12
USPC 705/26.8

(57) ABSTRACT

A method and system for providing a marketplace that enables enterprise collaboration. The method includes allowing an agent to receive a request for purchasing a product and place an order to provide the products to a customer. Further, the method includes allowing the agent to receive the requested products from a vendor and charge the customer for the products with a price as received from the vendor.

### TECHNICAL FIELD

The embodiments herein relates to a business marketplace for organized and unorganized sectors, and more particularly to an extended commerce platform that enables local agents to collaborate with various business entities for providing goods/services to customers at a reasonable cost.

### BACKGROUND

Electronic commerce (ecommerce) activities are generally conducted in public or consortium marketplaces. In such environments, buyers, suppliers, stakeholders, and the like entities collaborates with each other to provide effective services to customers. Providing goods or services to the customers at a reduced or reasonable cost involves significant challenges. A large part of costs cutting criteria depends on technology ecosystem that maintains business website, resources (such as servers, computers, and so on), site hosting, and the like required to create an ecommerce portal.

Many ecommerce organizations invest heavily in technology solutions. As a result, customer experience in terms of site performance may get improved thereby increasing overall service cost of the organization. Apart from having a robust web site and connectivity issues, the other challenges can include for example, but not limited to, integration with mobile devices, delivering more content on small screens, providing personalized services, targeting right customers, mode of payments, and the like

Conventional methods and system may include unorganized organizations with no concept of collaboration which can lead to poor utilization of resources thereby increasing the overall product cost for the customers. Further, due to higher fees and payment charges, the methods and system taps few online payments.

### SUMMARY

Accordingly the embodiments herein provide a method for providing a marketplace that enables enterprise collaboration. The method includes allowing an agent to receive a request for purchasing object(s) and place an order to provide the objects to a customer. Further, the method includes allowing the agent to receive the requested objects from a vendor and charge the customer a price/charge as received from the vendor for the objects.

Further, the method allows the agent to deliver the objects to the customer and access the vendor objects catalogue to place the order. The agent uses an enterprise wallet to charge the customer and to transfer the charge to the vendor.

Accordingly the embodiments herein provide a system for providing a marketplace that enables enterprise collaboration. The system includes a customer module configured to receive a request for purchasing object(s) from a customer and a vendor module configured to provide the object from vendor(s). Further, the system includes an agent module configured to place an order to the vendor, receive the object from the vendor, and charge the customer a charge/price as received from the vendor for the objects.

Further, the vendor module is configured to provide a vendor objects catalogue, which is accessed by the agent module to place the order. Further, the agent is configured to deliver the object to the customer, use an enterprise wallet to charge the customer, and transfer the charge using the enterprise wallet to the vendor.

The embodiments herein provide a method and system for providing a marketplace that enables enterprise collaboration.

The embodiments herein provide an extended commerce platform that enables organization and collaboration of various business entities at various levels.

The embodiments herein provide a system and method for enabling service delivery network to leverage e-commerce and vice versa in order to address outreach and logistic issues.

The embodiments herein provide a data repository for commerce across various domains in order to understand the correlation amongst various sectors and identify unexplored value chain.

The embodiments herein provide a mechanism for efficiently handling payments using an enterprise wallet.

The embodiments herein provide a method and system for offering product and services to customers at significantly reduced cost.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

The embodiments herein are illustrated in the accompanying drawings, throughout which like reference letters indicate corresponding parts in the various figures. The embodiments herein will be better understood from the following description with reference to the drawings, in which:

FIG. 1 is a schematic block diagram illustrates generally, among other things, a high level architecture of a system, according to embodiments as disclosed herein;

FIG. 2 is a block diagram illustrates generally various modules of the system as described in the FIG. 1, according to embodiments as disclosed herein;

FIG. 3 is a sequence diagram illustrates generally, various operations performed by the system as described in the FIGS. 1 and 2, according to embodiments as disclosed herein;

FIG. 4 is a flow diagram illustrates generally, a method for providing a marketplace that enables enterprise collaboration, according to embodiments as disclosed herein; and

FIG. 5 depicts a computing environment implementing the system and method, in accordance with various embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a method and system for providing a marketplace that enables enterprise collaboration. Unlike conventional systems and methods, the embodiments herein provide an extended commerce platform that enables organization and collaboration of various business entities to provide cost effective services to customers. The platform enables the electronic market accessible to micro-entrepreneurs in various businesses (organized/unorganized and/or small/big) and allows them to interact/compete with big organizations in the market with the help a local agent/franchise model. The system includes local agent(s), customer(s), vendor(s), and other business entities. The agent receives request from a customer to purchase one or more product(s). The agent uses an online portal to access the vendor's product catalogue provided by various vendors, such as to order the product(s) requested by the customer. The online portal described herein can include information about various products offered by different vendors. The agent selects a vendor and places an order for the products using the online portal. The vendor then arranges the product(s) and delivers to the agent. Further, the agent receives the product from the vendor and delivers the ordered product to the customer without making any alteration in price. The agent charges the customer the same price as received from the vendor.

The method and system disclosed herein is simple, robust, and reliable to offer goods and/or services to the customers at a significantly reduced cost. The system provides a franchise model by organizing various business entities at various business levels. For example, the system offers micro-entrepreneurs such as farmers, underserved/unexplored markets, small scale Industries, small organization, and the like in unorganized/organized sectors to offer their products/services to a larger community across the ecosystem and achieve scale of business with minimal marketing costs. Further, the system uses an enterprise wallet that enables the customers to pay cash-at-counter and reduces the cash handling risks. The wallet can be used to reduce the transaction cost associated with the payments. Furthermore, the proposed system and method can be implemented using the existing infrastructure, components, and modules, and may not require extensive set-up or instrumentation.

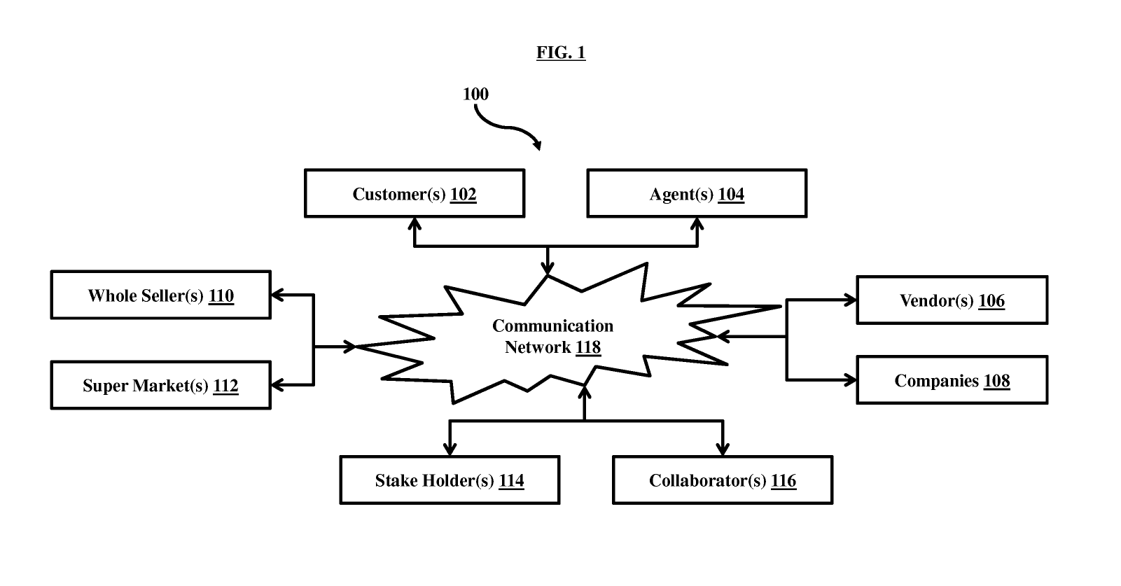

Referring now to the drawings, and more particularly to FIGS. 1 through 5, where similar reference characters denote corresponding features consistently throughout the figures, there are shown preferred embodiments.

Throughout the description, the terms product(s), good(s), service(s), and object(s) are used interchangeably.

Throughout the description, the terms charge, price, and amount are used interchangeably.

FIG. 1 is a schematic block diagram illustrates generally, among other things, a high level architecture of a system 100, according to embodiments as disclosed herein. In an embodiment, the system 100 can include business entities such as customer(s) 102, agent(s) 104, vendor(s) 106, companies 108, whole sailor(s) 110, super market(s) 112, stake holder(s) 114, and collaborator(s) 116 communicating among each other over a communication network 120. In an embodiment, the communication network 120 described herein can include for example, but not limited to, wireless network, wire line network, public network such as the Internet, private network, personal network, cellular network, Global System for Mobile Communication (GSM) network, Local Area Network (LAN), Wide Area Network (WAN), Metropolitan Area Network (MAN), a combination thereof, or any other communication network.

In an embodiment, the various business entities described herein can directly or indirectly (via third third-parties) communicate with each other. In an embodiment, the entities can access a hosted application (such as the network platform application) to indirectly communicate among each other. The network platform described herein can be hosted on local or remote servers and can be accessed by various business entities to perform business transaction(s). The system 100 can be configured to organize the various business entities and include different interfaces to collaborate the entities at various levels of business.

In an embodiment, the customers 102 described herein can be any local or remote user who can access the platform online or offline. In an embodiment, the agent 104 described herein can be a local agent or franchise that helps the vendor(s) 106, the companies 108, the whole sailor(s) 110, the super market(s) 112, stake holder(s) 114, the collaborator(s) 116, and the like in various businesses (may be small or big) to interact/compete with big organizations. The system 100 can provide a franchise model by allowing the agent 104 to interact with various business entities at various business levels.

In an embodiment, the vendor(s) 106 can provide products and/or services to the agent(s) 104. The vendor services described herein can include third-party services, traditional services, auditing services, accounting services, analytics services, and the like. The vendors 106 can interact with various other business entities such as for example, but not limited to, the companies 108, the whole seller(s) 110, the super market(s) 112, stake holder(s) 114, the collaborator(s) 116, other vendors, and the like to provide products and/or services to the agent(s) 104.

In an embodiment, the collaborator(s) 116 can be any additional party which may access or contribute to the retail value network platform. The collaborators 116 can include for example, but not limited to, trade associations, market analysts, retail or vendor software tool developers, any business entity, and the like.

Additionally, the system 100 allows the agent(s) 104, the vendor(s) 106, the companies 108, the whole sailor(s) 110, the super market(s) 112, the stake holder(s) 114, the collaborator(s) 116, and the like to communicate among each other, such as to provide insights into the product markets, access analytics for pricing, promotional analysis, collaborative features, and the like.

Thought the FIG. 1 shows a limited number of business entities but it is understood that another exemplary embodiment is not limited thereto. In addition to the illustrated entities, additional contributors or users may access the network platform and/or the system 100. These additional entities are not illustrated in the present figure for the sake of clarity. Further, more or fewer entities are can participate in the system without departing from the scope of the embodiments herein.

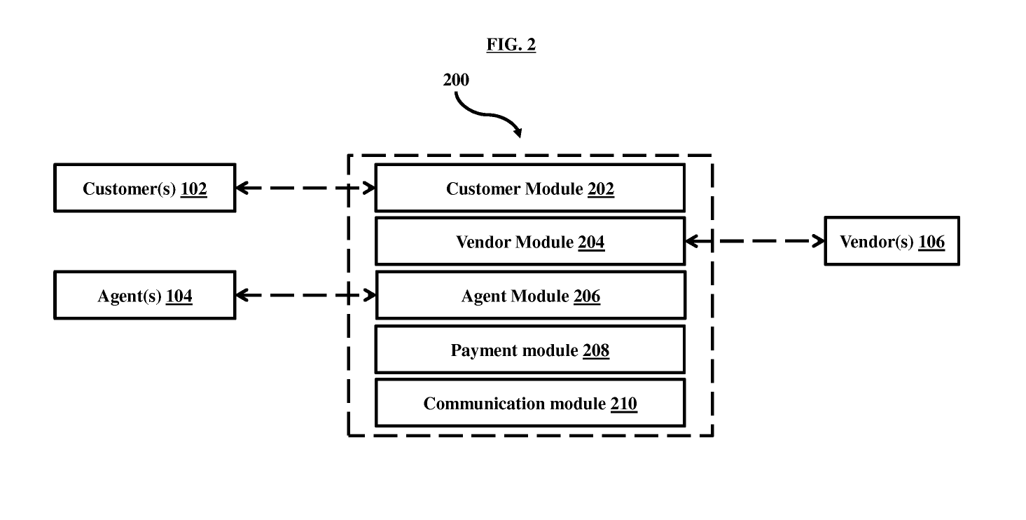

FIG. 2 is a block diagram illustrates generally various modules 200 of the system 100 as described in the FIG. 1, according to embodiments as disclosed herein. The system 100 can be configured to include a customer module 202, a vendor module 204, an agent module 206, a payment module 208, and a communication module 210, respectively.

In an embodiment, the customer module 202 can be configured to receive one or more requests (hereafter referred as request(s)) for purchasing one or more products/objects (hereafter referred as product(s)). The products/objects described herein can include tangible or intangible products/objects. In an embodiment, the customer module 202 can be configured to allow the customer 102 to place the request for the purchasing the products. A list/catalogue of products can be displayed to the customer 102, such as to assist the customer to choose the products of interest. In an embodiment, the customer module 202 can allow the customer 102 to place the request online or offline. For example, the customer 102 can use the hosted application of the platform to place a request online or the customer 102 can run into the nearest local shop or store and interact with the local agent/franchise 104 to place the request for the interested products.

In an embodiment, the vendor module 204 can be configured to provide vendor products catalog. The vendor module 204 can be configured to communicate with the customer module 202 to provide the products catalogue offered by the vendors 106. Each vendor 106 can collaborate with the system 100 and uses the hosted application of the platform to provide the list of products offered by the vendor 106.

In an embodiment, the agent module 206 can be configured to communicate with the customer module 202 and the vendor module 204, such as to process the request received from the customer 102. In an embodiment, the local agent or franchise 104 uses the agent module 206 to constantly interact with the business entities such as for example, but not limited to, the vendor(s) 106, the companies 108, the whole sailor(s) 110, the super market(s) 112, stake holder(s) 114, the collaborator(s) 116, and the like in various businesses (may be small or big) to interact/compete with big organizations. For example, the agents 104 can interact with micro-entrepreneurs such as farmers, farmer groups, extended markets, unexplored markets, small scale Industries, small organization, individuals, and the like in unorganized/organized sectors to offer their products/services to a larger community across the demographics and achieve scale of business with minimal marketing costs.

Further, the agent 104 can uses the agent module 206 to access the vendor products catalogues and place an order for the product requested by the customer 102. In an embodiment, upon receiving the order, the respective vendor 106 can arrange the product(s) and deliver to the agent 104. The agent 104 can further charge the customer 102 for the requested products without making any alteration in cost/charge. The agent 104 charges the customer 102 the same cost as received from the vendor 106. As the system 100 uses the franchise model by organizing and collaborating various business entities at various business levels, the system 100 allows the agent 104 to offer goods and/or services to the customers 102 at significantly reduced cost (or at the same price as received from the vendor 106).

In an embodiment, the payment module 208 can be configured to process the commerce transactions. The payment module 208 can be configured to include a unique enterprise wallet to process the transactions performed between the customer-vendor, vendor-vendor, vendor-agent, agent-agent, and the like. The enterprise wallet enables the customers 102 to pay cash-at-counter and reduces the cash handling risks. The wallet can be used to reduce the transaction cost associated with the payments and allow the agents to offer products and/or services to the customer at significantly reduced cost. Further, the payment module 208 can be configured to allow the customer 102 to use other modes of payments such as for example, but not limited to, cash-on-delivery, online banking, mobile wallet, near-field communication, credit cards, debit cards, or the like.

In an embodiment, the communication module 210 described herein can be configured to include interfaces to various internal and external sources, such as to enable communication among the customer 102, the agent 104, the vendor 106, and the like. The communication module 210 can be configured to include appropriate communication links/channel and interfaces to enable communication with various device/resources used in the communication network 118.

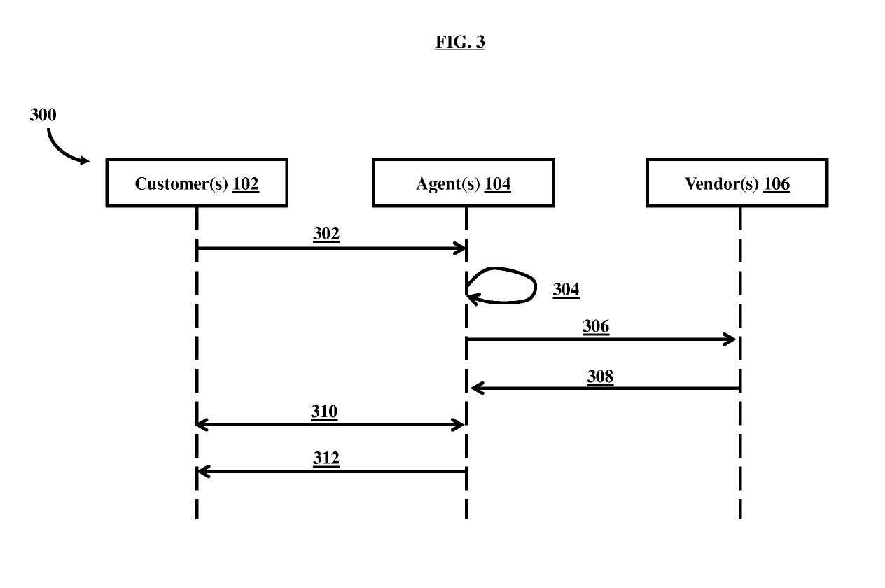

FIG. 3 is a sequence diagram illustrates generally, various operations 300 performed by the system 100 as described in the FIGS. 1 and 2, according to embodiments as disclosed herein. In an embodiment, at 302, the agent 104 receives request to purchase products from the customer 102. In an example, the customer module 202 can be configured to display the list/catalogue of the products offered by various vendors to the customer. The customer 102 uses the customer module 202 to provide request for purchasing the interested products. The customer module 202 allows the customer 102 to place the request online by accessing the system application or the customer 102 can visit the store or any other location and directly communicate with the agent 104 to place the request for purchasing the interested products.

In an embodiment, at 304, the agent 104 accesses the vendor products catalogue select the vendor for providing the products requested by the customer. In an example, the vendor module 204 can be configured to provide the list of products offered by the vendors 106. In an embodiment, one or more vendors can offer the same or substantially similar product at same or substantially similar price. The agent 104 can access the vendor products catalogue to select an appropriate vendor 106 for providing the products requested by the customer 102. In an embodiment, at 306, the agent 104 places an order for the products requested by the customer 102. In response to receiving the order, the vendor 106 arranges the requested products and delivers to the agent 104 as shown at 308.

In an embodiment, at 310, the agent 104 charges the customer 102 for the purchased products without making any changes in the cost/charge received from the vendor 106. In an embodiment, the agent 104 charges the customer 102 the same cost as received from the vendor 106. The agent 104 uses the enterprise wallet to process the transactions performed between the customer-vendor, vendor-vendor, vendor-agent, agent-agent, and the like. The enterprise wallet enables the customers 106 to pay cash-at-counter and reduces the cash handling risks. The wallet can be used to reduce the transaction cost associated with the payments and allow the agents 104 to offer the products and/or the services to the customers 102 at significantly reduced cost. Further, in an embodiment, the agent 104 can charge the customer 102 by using other modes of payments such as for example, but not limited to, cash-on-delivery, online banking, mobile wallet, near-field communication, credit cards, debit cards, or the like.

In an embodiment, at 310, the agent 104 delivers the product to the customer 102. Furthermore, the agent 104 can charge the customer 102 for the products at the time of delivery or before delivery of the products, or at the time of taking the order, or in advance, or the like.

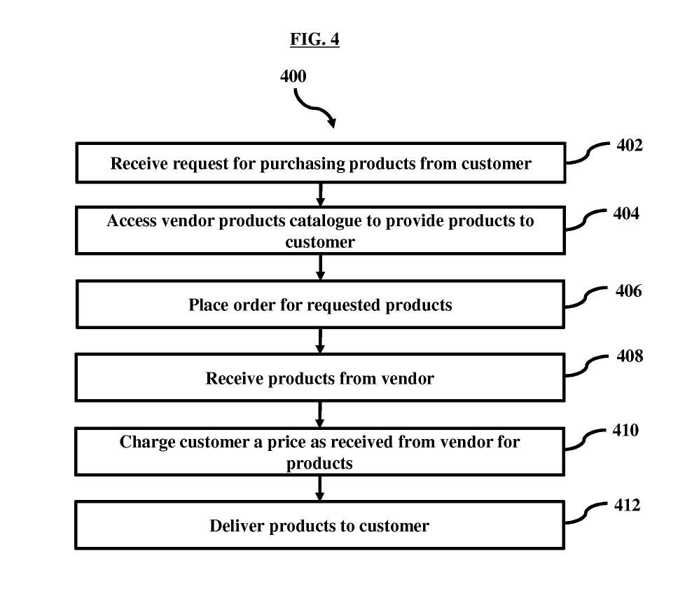

FIG. 4 is a flow diagram illustrates generally, a method 400 for providing a marketplace that enables enterprise collaboration, according to embodiments as disclosed herein. The various steps performed by the method 400 are summarized in various individual acts where some of the steps may be performed by the customer 102, the agent 104, the vendor 106, and the like. Further, the FIG. 4 and the other description described herein provide a basis for a control program which can be easily implemented by a microprocessor, a microcontroller, or a combination thereof.

In an embodiment, at act 402, the method 400 includes receiving a request for purchasing products from a customer. In an example, the method 400 allows the customer 102 to provide the request for purchasing the products. The customer 102 can provides the request online by accessing the system application or the customer 102 can visit the store or any other location and directly communicate with the agent 104 to place the request for purchasing the interested products.

In an embodiment, at act 404, the method 400 includes accessing vendor products catalogue to provide the products to the customer. In an example, the method 400 allows each vendor 106 to provide the list of products offered by them. In an embodiment, one or more vendors can offer the same or substantially similar product and same or substantially similar price. The method 400 allows the agent 104 to access the vendor products catalogue to select an appropriate vendor 106 for providing the products requested by the customer 102.

In an embodiment, at act 406, the method 400 includes placing an order for the requested products. In an example, the method 400 allows the agent 104 to place an order to the vendor 106 for the products requested by the customer 102. In an embodiment, at act 408, the method 400 includes receiving the requested products from the vendor 106. In an example, in response to receiving the order, the vendor 106 arranges the products and delivers to the agent 104.

In an embodiment, at act 410, the method 400 includes charging the customer a price as received from the vendor for the products. In an example, the method 400 allows the agent 104 to charge the customer 102 for the purchased products without making any changes in the price received from the vendor 106. The agent 104 charges the customer 102 the same cost as received from the vendor 106. Further, the method 400 allows the agent 104 to use the enterprise wallet to process the transactions performed between the customer-vendor, vendor-vendor, vendor-agent, agent-agent, and the like. The wallet can be used to reduce the transaction cost associated with the payments and allow the agents 104 to offer the products and/or the services to the customer 102 at significantly reduced cost. Further, in an embodiment, the method 400 allows the agent 104 to charge the customer 102 using other modes of payments such as for example, but not limited to, cash-on-delivery, online banking, mobile wallet, near-field communication, credit cards, debit cards, or the like.

In an embodiment, at act 412, the method 400 includes delivering the products to the customer. In an example, the method 400 allows the agent 104 to deliver the product to the customer 102. Further, the agent 104 can charge the customer 102 for the products at the time of delivery or before delivery of the products, or at the time of taking the order, or in advance, or the like.

The various steps, blocks, operations, and acts described with respect to the FIGS. 3 and 4 can be performed in sequential order, in random order, simultaneously, parallel, or a combination thereof. Further, in some embodiments, some of the steps, blocks, operations, and acts can be omitted, skipped, modified, or added without departing from scope of the embodiments herein.

Though the above description focuses on a franchise model but, it is to be understood that the embodiments herein can also be used without using any franchise/agent. Further, the embodiments herein can also used to perform end customer transactions and can be used in any commerce platform or applications.

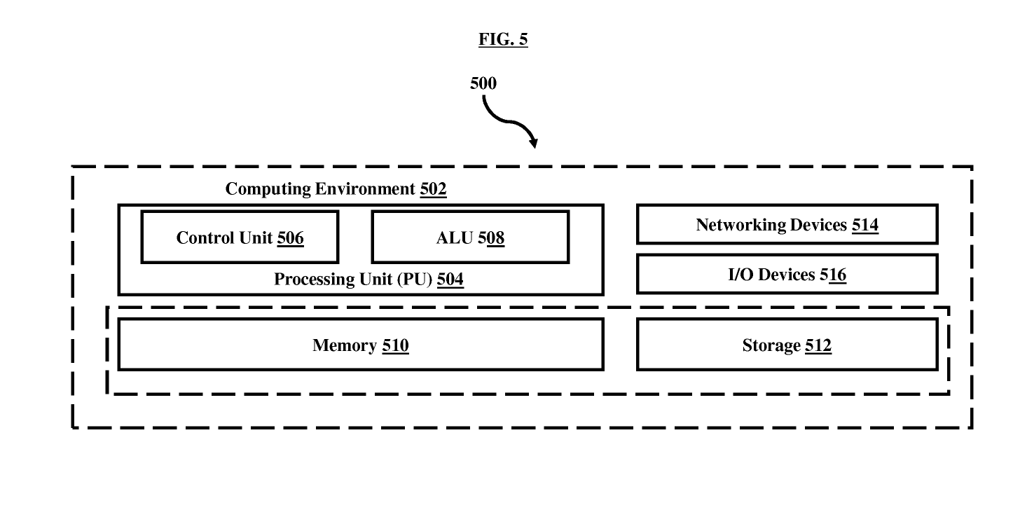

FIG. 5 illustrates a computing environment 502 implementing the method and systems as disclosed in the embodiments herein. As depicted the computing environment 502 comprises at least one processing unit 504 that is equipped with a control unit 506 and an Arithmetic Logic Unit (ALU) 508, a memory 510, a storage unit 512, plurality of networking devices 514 and a plurality Input output (I/O) devices 516. The processing unit 504 is responsible for processing the instructions of the algorithm. The processing unit 504 receives commands from the control unit 506 in order to perform its processing. Further, any logical and arithmetic operations involved in the execution of the instructions are computed with the help of the ALU 508.

The overall computing environment 502 can be composed of multiple homogeneous and/or heterogeneous cores, multiple CPUs of different kinds, special media and other accelerators. The processing unit 504 is responsible for processing the instructions of the algorithm. Further, the plurality of processing units 504 may be located on a single chip or over multiple chips.

The algorithm comprising of instructions and codes required for the implementation are stored in either the memory unit 510 or the storage 512 or both. At the time of execution, the instructions may be fetched from the corresponding memory 510 and/or storage 512, and executed by the processing unit 504. In case of any hardware implementations various networking devices 514 or external I/O devices 516 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 5 include blocks, steps, operations, and acts, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for providing a marketplace that enables enterprise collaboration, the method comprising:
receiving at least one request for purchasing at least one object from a customer;
placing at least one order to at least one vendor to provide said at least one object;
receiving said at least one object from said at least one vendor; and
charging said customer a charge as received from said at least one vendor for said at least one object.

2. The method of claim 1, wherein said at least one request is received by an agent.

3. The method of claim 1, wherein said at least one order is placed by said agent.

4. The method of claim 1, wherein said at least one object is received by said agent.

5. The method of claim 1, wherein said charge is charged by said agent.

6. The method of claim 1, wherein said method further comprises delivering said at least one object to said customer.

7. The method of claim 6, wherein said at least one object is delivered by said agent.

8. The method of claim 1, wherein said method further comprises accessing at least one vendor objects catalogue to place said at least one order.

9. The method of claim 1, wherein said agent uses an enterprise wallet to charge said customer.

10. The method of claim 1, wherein said method further comprises transferring said charge using said enterprise wallet to said at least one vendor.

11. The method of claim 10, wherein said charge is transferred by said agent.

12. A system for providing a marketplace that enables enterprise collaboration, the system comprises:
a customer module configured to receive at least one request for purchasing at least one object from a customer;
a vendor module configured to provide said at least one object from at least one vendor; and
an agent module configured to:
place at least one order to said at least one vendor;
receive said at least one object from said at least one vendor; and
charge said customer a charge as received from said at least one vendor for said at least one object.

13. The system of claim 12, wherein said agent module is further configured to deliver said at least one object to said customer.

14. The system of claim 13, wherein said at least one object is delivered by an agent.

15. The system of claim 12, wherein said vendor module is further configured to provide at least one vendor objects catalogue.

16. The system of claim 12, wherein said agent module is further configured to access said at least one vendor objects catalogue to place said at least one order.

17. The system of claim 12, wherein said system further comprises a payment module configured to provide an enterprise wallet.

18. The system of claim 12, wherein said agent module is further configured to use said enterprise wallet to charge said customer.

19. The system of claim 12, wherein said agent module is further configured to transfer said charge using said enterprise wallet to said at least one vendor.

20. A computer program product transmitting optimal video over a network channel, the product comprising:
an integrated circuit comprising at least one processor; and
at least one memory having a computer program code within said circuit, wherein said at least one memory and said computer program code with said at least one processor cause said product to:
receive at least one request for purchasing at least one object from a customer;
place at least one order to at least one vendor to provide said at least one object;
receive said at least one object from said at least one vendor; and
charge said customer a charge as received from said at least one vendor for said at least one object.
